(19) United States
(12) Patent Application Publication
(10) Pub. No.: US 2014/0145118 A1
(43) Pub. Date: May 29, 2014

(54) Dispersions Comprising Polythiophenes With A Defined Sulfate Content

(71) Applicants: Wilfried Lovenich, Bergisch Gladbach (DE); Arnulf Scheel, koln (DE); Rudolf Hill, Langenfeld (DE)

(72) Inventors: Wilfried Lovenich, Bergisch Gladbach (DE); Arnulf Scheel, koln (DE); Rudolf Hill, Langenfeld (DE)

(73) Assignee: Heraeus Precious Metals GmbH & Co. KG, Hanau (DE)

(21) Appl. No.: 13/879,197

(22) PCT Filed: Oct. 7, 2011
(86) PCT No.: PCT/EP11/05021

§ 371 Date: Jun. 24, 2013

Related U.S. Application Data
(60) Provisional application No. 61/471,861, filed on Apr. 5, 2011.

(30) Foreign Application Priority Data
Oct. 12, 2010 (DE) 10 2010 048 031.2

(51) Int. Cl. H01B 1/12

(52) U.S. Cl. CPC H01B 1/127
USPC 252/500

(57) ABSTRACT

The present invention relates to a method for producing a composition comprising polythiophene, comprising the method steps: I) provision of a composition Z1 comprising thiophene monomers and an oxidising agent; II) oxidative polymerisation of the thiophene monomers by reducing the oxidising agent to a reduction product and oxidation of the thiophene monomer, forming a composition Z2 comprising a polythiophene and the reduction product; III) at least partial removal of the reduction product from the composition Z2 obtained in method step II), obtaining a composition Z3; wherein the composition Z3 has a sulfate content in the range from 100 ppm to 1,000 ppm, based on the total weight of the composition Z3. The present invention also relates to a composition obtainable as the composition Z3 produced with this method, a composition comprising a polythiophene, a layer construction, an electronic component and the use of a composition.

The present invention relates to a method for producing compositions comprising a polythiophene, a composition obtainable by means of said method, a composition comprising a polythiophene, a layer construction, an electronic component, and the use of a composition.

Conductive polymers are growing in commercial importance, since polymers have advantages over metals with regard to processing ability, weight and the targeted adjustment of properties by means of chemical modification. Examples of known π-conjugated polymers are polypyrroles, polythiophenes, polyanilines, polyacetylenes, polyphenylenes and poly(p-phenylene-vinylenes). Layers made from conductive polymers are used in many technical fields, for example, as polymer counter electrodes in capacitors or for through-contacting in electronic circuit boards. The production of conductive polymers is achieved chemically or electrochemically by oxidation from monomer precursors, for example, substituted thiophenes, pyrroles and anilines and their respective, optionally oligomeric, derivatives. Chemical oxidative polymerisation, in particular, is widely used, since it can be achieved easily technically in a liquid medium and on many different substrates.

A particularly important technically used polythiophene is poly(ethylene-3,4-dioxythiophene) (PEDOT or PEDT) disclosed, for example, in EP 0 339 340 A2, which is produced by chemical polymerisation of ethylene-3,4-dioxythiophene (EDOT or EDT) and has very good conductivity in its oxidised form. An overview of numerous poly(alkylene-3,4-dioxythiophene) derivatives, particularly poly(ethylene-3,4-dioxythiophene) derivatives, their monomer components, synthesis and uses is set out by L. Groenendaal, F. Jonas, D. Freitag, H. Pielartzik & J. R. Reynolds in Adv. Mater. 12, (2000) pp. 481-494.

Of particular technical importance are the dispersions of PEDOT with polyanions disclosed for example in EP 0 440 957 A2, for example, polystyrene sulfonic acid. From these dispersions, transparent conductive films can be produced, for which many uses have been found, for example as an antistatic coating or as a hole injection layer in organic light-emitting diodes (OLEDs) as disclosed in EP 1 227 529 A2.

The polymerisation of EDOT takes place in an aqueous solution of the polyanion and a polyelectrolyte complex is formed. Cationic polythiophenes which comprise polymeric anions as counterions for charge compensation are also often known among experts as polythiophene/polyanion-complexes (PEDOT/PSS complexes). Due to the polyelectrolyte properties of PEDOT as a polycation and of PSS as a polyanion, this complex is not a true solution but rather a dispersion. The extent to which polymers or parts of polymers are dissolved or dispersed depends on the mass ratio of the polycation and the polyanion, the charge densities of the polymers, the salt concentration in the surroundings and on the nature of the surrounding medium (V. Kabanov, Russian Chemical Reviews 74, 2005, 3-20). These transitions can be fluid. For this reason, no distinction is made in the following between the expressions “dispersed” and “dissolved”. Similarly, no distinction is made between “dispersing” and “dissolving” or between “dispersant” and “solvent”. Rather, these expressions are used here as equivalent.

The disadvantage of the dispersions of electrically conductive polymers described in the prior art, particularly in relation to the PEDOT/PSS dispersions known from the prior art, is that they tend, on long storage, to “gel”. This gelling of the dispersion manifests itself, inter alia, therein that if, for example, the dispersion is poured out of a vessel, the dispersion does not flow evenly, but leaves behind regions in which hardly any dispersion remains. A non-uniform flow of the material is often to be seen, which is characterised by frequent rupturing. On substrates onto which the dispersion is applied for coating purposes, it also spreads out very unevenly. However, since PEDOT/PSS dispersions are often used for producing electrically conductive layers and therefore have to be applied to substrate surfaces, this gelling also decisively influences the homogeneity and thus the electrical properties of the PEDOT/PSS layer. Furthermore, the PEDOT/PSS dispersions known from the prior art are also characterised in that the layers obtained with such dispersions often have an electrical conductivity that is in need of improvement.

It is therefore an object of the present invention to overcome the disadvantages of the prior art associated with compositions comprising polythiophenes, particularly associated with PEDOT/PSS dispersions and with laminated bodies produced from such compositions or from said dispersions.

In particular, it is an object of the present invention to provide a method for producing a composition comprising polythiophenes, preferably a PEDOT/PSS dispersion which is characterised in particular by hardly any or, preferably no, tendency to gel even after a long storage time.

Furthermore, the composition or dispersion obtainable with this method should be thereby distinguished that a layer produced from said composition or dispersions is characterised by having a particularly high electrical conductivity.

It was therefore also an object of the present invention to provide a composition comprising polythiophenes, and preferably a PEDOT/PSS dispersion which, compared with the compositions or dispersions known from the prior art, is characterised by a particularly advantageous combination of the properties of good processability and high electrical conductivity in a layer produced therefrom.

A further object of the invention is the smoothing of busbars. In the case of OLED and OPV structures, a low surface roughness is required, since further layers which usually have a thickness in the range from 10 nm to 200 nm are applied to the polythiophene layer. If there is a high degree of roughness, this layer structure is disrupted.

A contribution to solving these problems is made by a method for producing a composition comprising a polythiophene, comprising the method steps:
I) provision of a composition Z1 comprising thiophene monomers and an oxidising agent;
II) oxidative polymerisation of the thiophene monomers by reducing the oxidising agent to a reduction product and oxidation of the thiophene monomer, to form a composition Z2 comprising a polythiophene and the reduction product;
III) at least partial removal of the reduction product from the composition Z2 obtained in method step II), to obtain a composition Z3;
   wherein the composition Z3 has a sulfate content in the range from 100 ppm to 1,000 ppm, preferably in the range from 100 ppm to 500 ppm and particularly preferably in the range from 100 ppm to 200 ppm, in each case based on the total weight of the composition Z3.

Surprisingly, it was found that the storage stability of compositions comprising polythiophenes, particularly of PEDOT/PSS dispersions, with regard to the “gelling behaviour” thereof, as well as the conductivity of layers obtained on the basis of said compositions or dispersions can be significantly improved if a particular content of sulfate, characterised by a minimum value of approximately 100 ppm and a maximum value of approximately 1,000 ppm is established in said compositions or dispersions. If the concentration of sulfate is below 100 ppm, then a significant increase in the conductivity cannot be achieved by means of the added sulfate. If the concentration of sulfate is above 1000 ppm, then a significant increase in the viscosity of the composition or dispersion is observed, which eventually leads to gelling and impedes the processing of the composition or dispersion.

In method step I) of the method according to the invention, a composition Z1 comprising thiophene monomers and an oxidising agent is first provided.

The thiophene monomers used are preferably compounds having the formula (I)

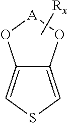

wherein
A stands for an optionally substituted C₁-C₅— alkylene residue,
R independently of each other, stands for H, a linear or branched, optionally substituted C₁-C₁₈-alkyl residue, an optionally substituted C₅-C₁₂-cycloalkyl residue, an optionally substituted C₆-C₁₄-aryl residue, an optionally substituted C₇-C₁₈-aralkyl residue, an optionally substituted C₁-C₄-hydroxyalkyl residue or a hydroxyl residue,
x stands for a whole number from 0 to 8, and
   in the event that a plurality of groups R are bound to A, said groups can be similar or different. The general formula (I) should be understood such that the substituent R can be bound x times to the alkylene residue A.

Particularly preferred are thiophene monomers having the general formula (I), where A stands for an optionally substituted C₂-C₃-alkylene residue and x stands for 0 or 1. Especially preferred as a thiophene monomer is 3,4-ethylenedioxythiophene, which is polymerised in method step II), to obtain poly(3,4-ethylenedioxythiophene).

C₁-C₅-alkylene residues A according to the invention are preferably methylene, ethylene, n-propylene, n-butylene or n-pentylene. C₁-C₁₈-alkyl R preferably stands for linear or branched C₁-C₁₈-alkyl residues such as methyl, ethyl, n- or iso-propyl, n-, iso-, sec- or tert-butyl, n-pentyl, 1-methylbutyl, 2-methylbutyl, 3-methylbutyl, 1-ethyl propyl, 1,1-dimethylpropyl, 1,2-dimethylpropyl, 2,2-dimethylpropyl, n-hexyl, n-heptyl, n-octyl, 2-ethylhexyl, n-nonyl, n-decyl, n-undecyl, n-dodecyl, n-tridecyl, n-tetradecyl, n-hexadecyl or n-octadecyl, C₅-C₁₂-cycloalkyl residues R stand, for example, for cyclopentyl, cyclohexyl, cycloheptyl, cyclooctyl, cyclononyl or cyclodecyl, C₆-C₁₄-aryl residues R stand, for example, for phenyl or naphthyl, and C₇-C₁₈-aralkyl residues R stand, for example, for benzyl, o-, m-, p-tolyl, 2,3-, 2,4-, 2,5-, 2,6-, 3,4-, 3,5-xylyl or mesityl. The above listing serves for exemplary explanation of the invention and should not be regarded as exclusive.

Other possible substituents of the residues A and/or the residues R in the context of the invention are numerous organic groups, for example, alkyl-, cycloalkyl-, aryl-, aralkyl-, alkoxy-, halogen-, ether-, thioether-, disulfide-, sulfoxide-, sulfone-, sulfonate-, amino-, aldehyde-, keto-, carboxylic acid ester-, carboxylic acid-, carbonate-, carboxylate-, cyano-, alkylsilane- and alkoxysilane groups as well as carboxylic acid amide groups.

The compound provided in method step I) also comprises, in addition to the thiophene monomer, an oxidising agent. As the oxidising agent, the oxidising agents suitable for oxidative polymerisation of pyrrole can be used; said oxidising agents are described, for example, in J. Am. Chem. Soc. 85, 454 (1963). Preferably, for practical reasons, economical and easily used oxidising agents, for example, iron-III salts such as FeCl₃, Fe(ClO₄)₃ and the iron-III salts of organic acids and of inorganic acids having organic groups, also H₂O₂, K₂Cr₂O₇, alkali- and ammonium persulfates, alkali perborates, potassium permanganate and copper salts, such as copper tetrafluoroborate. The use of the persulfates and iron-III salts of organic acids and of inorganic acids having organic groups has the great advantage in practice, that they do not have a corrosive effect. Examples of iron-III salts of inorganic acids having organic groups are the iron-III salts of sulfuric acid semiesters of C₁-C₂₀-alkanols, for example, the Fe-III salt of lauryl sulfate. Examples of iron-III salts of organic acids are: the Fe-III salts of C₁-C₂₀-alkyl sulfonic acids, for example, methane and dodecane sulfonic acids; of aliphatic C₁-C₂₀ carboxylic acids such as 2-ethylhexyl carboxylic acid; of aliphatic perfluorocarboxylic acids, such as trifluoroethanoic and perfluorooctanoic acids; aliphatic dicarboxylic acids, for example, oxalic acid and above all, aromatic sulfonic acids, optionally substituted with C₁-C₂₀ alkyl groups, for example benzenesulfonic acid, p-toluenesulfonic acid and dodecylbenzene sulfonic acid.

Theoretically, for the oxidative polymerisation of the thiophene monomers of formula I, per mole of thiophene, 2.25 equivalents of oxidising agent are needed (see e.g. J. Polym. Sc., Part A, Polymer Chemistry, vol. 26, p. 1287 (1988)). However, in practice, the oxidising agent is normally used in a certain excess amount, e.g. an excess of 0.1 to 2 equivalents per mole of thiophene.

According to a particularly preferable embodiment of the method according to the invention, the composition provided in method step I) also comprises a polyanion, wherein a polyanion is preferably understood to be a polymeric anion which comprises at least 2, preferably at least 3, particularly preferably at least 4, and especially preferably at least 10 identical, anionic monomer repeating units, which however do not necessarily have to be directly linked to one another.

Polyanions can be, for example, anions of polymeric carboxylic acids, for example, polyacrylic acids, polymethacrylic acid or polymaleic acid, or polymeric sulfonic acids, for example, polystyrene sulfonic acids and polyvinyl sulfonic aids. Said polycarboxylic and polysulfonic acids can also be copolymers of vinyl carboxylic acids and vinyl sulfonic acids with other polymerisable monomers, for example, acrylic acid esters and styrene. Preferably comprised in the dispersions provided in method step I) as a polyanion, is an anion of a polymeric carboxylic or sulfonic acid.

Particularly preferable as a polyanion is the anion of polystyrene sulfonic acid (PSS). The molecular weight (M_{w}) of the polyacids providing the polyanions is preferably in the range from 1,000 to 2,000,000, particularly preferably 2,000 to 500,000. Determination of the molecular weight is carried out by means of gel permeation chromatography with the aid of polystyrene sulfonic acids having defined molecular weights as the calibration standard. The polyacids or the alkali metal salts thereof are commercially available, for example, polystyrene sulfonic acids and polyacrylic acids, or are produced with known methods (see, for example, Houben Weyl, Methoden der organischen Chemie [Methods of Organic Chemistry], vol. E20 Makromolekulare Stoffe [Macromolecular Substances], part 2 (1987), p. 1141 ff.).

The polyanion and the thiophene monomer can be comprised in the composition provided in method step I), particularly in a weight ratio of from 0.5:1 to 50:1, preferably of from 1:1 to 30:1, particularly preferably of from 2:1 to 20:1.

According to the invention, it is also preferable that the composition provided in method step I) comprises, besides the thiophene monomer, the oxidising agent and optionally the polyanion, a solvent or a dispersant or a solvent and/or dispersant mixture, in which said components are dissolved or dispersed. The following substances are named, for example, as solvents and/or dispersants: aliphatic alcohols such as methanol, ethanol, i-propanol and butanol; aliphatic ketones such as acetone and methylethylketone; aliphatic carboxylic acid esters such as ethyl acetate and butyl acetate; aromatic hydrocarbons such as toluene and xylene; aliphatic hydrocarbons such as hexane, heptane and cyclohexane; chlorohydrocarbons such as dichloromethane and dichloroethane; aliphatic nitriles such as acetonitrile, aliphatic sulfoxides and sulfones such as dimethyl sulfoxide and sulfolane; aliphatic carboxylic acid amides such as methylacetamide, dimethylacetamide and dimethylformamide; aliphatic and araliphatic ethers such as diethylether and anisole. Furthermore, water or a mixture of water and the aforementioned organic solvents can be used as solvents or dispersants. Preferred solvents and dispersants are water or other protic solvents such as alcohols, for example, methanol, ethanol, i-propanol and butanol, as well as mixtures of water with said alcohols, a particularly preferred solvent or dispersant being water.

The quantity or concentration in which the thiophene monomers and polyanions are comprised in the composition prepared in method step I) is preferably chosen so that stable polythiophene/polyanion dispersions are obtained, the solids content of which lies in the range from 0.05% to 50% by weight, preferably 0.1% to 10% by weight and particularly preferably 1% to 5% by weight.

In method step II) of the method according to the invention, the thiophene monomers are oxidatively polymerised by reduction of the oxidising agent to a reduction product and oxidation of the thiophene monomer, to form a composition Z2 preferably comprising cationic polythiophene and the reduction product, wherein said polymerisation preferably takes place at a temperature in the range from 0° C. to 100° C. If polyanions were present in the compositions provided in method step I), cationic polythiophenes are obtained in the method step II), which comprise polyanions as counterions for charge compensation, and which are also often described by experts, as stated above, as polythiophene/polyanion complexes. According to the invention, particularly preferred polythiophene/polyanion complexes are PEDOT/PSS complexes.

The prefix “poly” should be understood, within the context of the invention, to mean that more than one identical or different repeating units is comprised in the polymer or polythiophene. The polythiophenes formed in method step II) comprise a total of n repeating units of the general formula (I), wherein n is a whole number from 2 to 2,000, preferably from 2 to 100. The repeating units of the general formula (I) within a polythiophene can be identical or different, depending on whether identical or different thiophene monomers were present in the composition prepared in method step I).

The polythiophenes formed in method step II) by oxidative polymerisation, and particularly the aforementioned poly(3,4-ethylenedioxythiophene), can be neutral or cationic. In a particularly preferred embodiment, they are cationic and the expression “cationic” relates only to the charges located on the polythiophene main chain. Depending on the substituent on the groups R, the polythiophenes can carry positive and negative charges in the structural unit, wherein the positive charges are situated on the polythiophene main chain and the negative charges may optionally be situated on the groups R substituted with sulfonate or carboxylate groups. The positive charges of the polythiophene main chain can be partially compensated by the anionic groups possibly present on the groups R. Seen overall, the polythiophenes in these cases can be cationic, neutral or even anionic. Nevertheless, in the context of the invention, they are all considered to be cationic polythiophenes, since the positive charges on the polythiophene main chain are decisive. The number of positive charges is preferably at least 1 and a maximum of n, where n is the total number of all (identical or different) repeating units within the polythiophene.

In method step III) of the method according to the invention, the reduction product is at least partially removed from the composition Z2 obtained in method step II), to obtain a composition Z3. This removal of the reduction product preferably takes place through the treatment of the composition Z2 with one or more ion exchangers. By means of this method, the composition obtained in method step II) is freed not only from the reduction product, but generally from salts still present. The ion exchanger or ion exchangers can be stirred, for example, into the composition Z2 obtained in method step II), or the composition Z2 obtained in method step II) is passed through one or more column(s) filled with ion exchanger. It is particularly preferable to treat the composition obtained in method step II) both with an anion exchanger and with a cation exchanger. Examples of suitable cation and anion exchangers are the ion exchangers obtainable from Lanxess AG under the trade name of LEWATIT.

According to the invention, it is particularly preferable that the composition Z2 or the composition Z3 is a composition comprising a PEDOT/PSS complex. Preferably the composition Z2 or the composition Z3 is a PEDOT/PSS dispersion. Concrete examples of a composition Z3 in which the sulfate content has not yet been set within the range from 100 ppm to 1,000 ppm are the dispersions with the name “Clevios®P” obtainable from H.C. Stark Clevios GmbH.

The method according to the invention is characterised in that the composition Z3 has a sulfate content in the range from 100 ppm to 1,000 ppm, preferably in the range from 100 ppm to 500 ppm and particularly preferably in the range from 100 ppm to 200 ppm, in each case based on the total weight of the composition Z3. In this case, what is meant by the expression “sulfate” is the non-chemically bound anion SO₄^{2—} which is preferably comprised in the composition in a dissolved form. The expression “sulfate” is also used to mean the protonated forms of the sulfate ion HSO₄⁻ or H₂SO₄, which are present at low pH values.

In this regard, it is preferable to adjust the sulfate content in the composition Z3 by adding sulfuric acid or a salt of sulfuric acid to the composition Z3. Preferably, after the at least partial removal of the reduction product which, as stated above, is preferably carried out by treating the composition Z2 with one or more ion exchangers, suitable quantities of sulfuric acid or suitable quantities of a salt of sulfuric acid or suitable quantities of a mixture of sulfuric acid and a salt of sulfuric acid are added to the composition obtained by this means. The salt of sulfuric acid used may be any of the sulfuric acid salts known to a person skilled in the art, wherein the use of water-soluble sulfuric acid salts is particularly preferable. Examples of suitable sulfuric acid salts are for example the alkali salts of sulfuric acid, for example, sodium sulfate or potassium sulfate, ammonium salts of sulfuric acid, for example, ammonium sulfate or ammonium hydrogensulfate, alkaline earth salts of sulfuric acid, for example, magnesium sulfate or calcium sulfate, or sulfate salts of trivalent cations, for example, aluminium sulfate or alums.

A contribution to solving the aforementioned problem is also made by a composition which is obtainable as composition Z3 with the method described above and which preferably has a sulfate content of in the range from 100 ppm to 1,000 ppm, preferably in the range from 100 ppm to 500 ppm and particularly preferably in the range from 100 ppm to 200 ppm, in each case based on the total weight of the composition Z3.

A contribution to solving the aforementioned problem is also made by a composition comprising a polythiophene, wherein the composition comprises, in addition to the polythiophene, in the range from 100 ppm to 1,000 ppm of sulfate, preferably 100 to 500 ppm of sulphate and particularly preferably 100 ppm to 200 ppm of sulfate, in each case based on the total weight of the composition. In this case also, what is meant by the expression “sulfate” is the non-chemically bound anion SO₄²⁻ which is preferably comprised in the composition in a dissolved form. The expression “sulfate” is also used to mean the protonated forms of the sulfate ion HSO₄⁻ or H₂SO₄, which are present at low pH values.

According to a preferred embodiment of the composition according to the invention, the iron concentration of the composition Z3 is less than 200 ppm, preferably less than 50 ppm and especially preferably, less than 10 ppm, in each case based on the total weight of the composition.

According to a preferred embodiment, the particle concentration of particulate ion exchanger based on cross-linked polystyrene derivatives in a dispersion determined by the method below is less than 20, preferably less than 10 and particularly preferably less than 5. This can apply also if other ion exchangers based on cross-linked polystyrene derivatives are used. The particle size of the particulate ion exchanger, which often lies in a range from 0.1 mm to 4 mm, can also include smaller particle fractions in a range from 5 μm to 100 μm, particularly if the ion exchangers are subject to mechanical loading.

In another preferred embodiment, both the iron concentration and the ion exchanger content lie within the limits set out in the previous two paragraphs.

According to a preferred embodiment of the composition according to the invention, the polythiophene is poly(3,4-ethylenedioxythiophene).

It is also preferred, according to the invention, that the composition also comprises, in addition to the polythiophene, and preferably in addition to the poly(3,4-ethylenedioxythiophene), a polyanion, wherein as polyanions, the compounds which were given above as preferred polyanions in connection with the method according to the invention are preferred. In this connection, particularly preferred polyanions are anions of polystyrene sulfonic acid (PSS). In this regard, it is also preferable that the composition according to the invention comprises a PEDOT/PSS complex. As described above with regard to the method according to the invention, such compositions can be obtained in that 3,4-ethylenedioxythiophene is oxidatively polymerised in the presence of polystyrene sulfonic acid. In this regard, it is particularly preferred that the composition according to the invention is a PEDOT/PSS dispersion.

According to a particular embodiment of the composition according to the invention, said composition has at least one, but preferably all of the following properties:
i) a viscosity in a range from 2 mPas to 1,000 mPas, preferably in a range from 10 mPas to 500 mPas and particularly preferably in a range from 60 mPas to 250 mPas;
ii) a conductivity according to the test method described herein of at least 600 S/cm, preferably at least 500 S/cm and particularly preferably of at least 400 S/cm;
iii) a PEDOT/PSS content in a range from 0.05% to 50% by weight, preferably from 0.1% to 10% by weight and particularly preferably from 1% to 5% by weight, in each case based on the total weight of the composition.

Particularly preferable according to the invention is a composition which has the properties i) and ii).

A contribution to solving the aforementioned problem is also made by a layer construction, comprising

A) a substrate with a substrate surface and
B) a layer at least partially covering the substrate surface,
wherein the layer is formed from the solid comprised in the composition according to the invention or in the composition obtainable through the method according to the invention.

Substrates that are preferable in this context are plastics films, and particularly preferable are transparent plastics films which usually have a thickness in the range from 5 μm to 5,000 μm, preferably in the range from 10 μm to 2,500 μm and particularly preferably in the range from 100 μm to 1,000 μm. Such plastics films can be based, for example, on polymers such as polycarbonates, polyesters, for example, PET and PEN (polyethylene terephthalate or polyethylene naphthalene dicarboxylate), copolycarbonates, polysulfones, polyethersulfones (PES), polyimides, polyamides, polyethylene, polypropylene or cyclic polyolefins or cyclic olefin copolymers (COC), polyvinyl chloride, polystyrene, hydrated styrene polymers or hydrated styrene copolymers.

The surface of the substrates can possibly be pre-treated before coating with the composition according to the invention, for example, by corona treatment, flame treatment, fluorination or plasma treatment, in order to improve the polarity of the surface and thus to improve the wettability and the chemical affinity.

Before the composition according to the invention or the composition obtainable with the method according to the invention is applied to the substrate surface for the purpose of forming a layer, further additives which increase the conductivity can be added to the composition, for example, compounds comprising ether groups, for example, tetrahydrofuran, lactone group-comprising compounds such as butyrolactone, valerolactone, amide- or lactam-group comprising compounds such as caprolactam, N-methylcaprolactam, N,N-dimethylacetamide, N-methylacetamide, N,N-dimethylformamide (DMF), N-methylformamide, N-methylformanilide, N-methylpyrrolidone (NMP), N-octylpyrrolidone, pyrrolidone, sulfones and sulfoxides, for example, sulfolane (tetramethylene sulfone), dimethyl sulfoxide (DMSO), sugar or sugar derivatives, such as, for example, sucrose, glucose, fructose, lactose, sugar alcohols, for example, sorbitol, mannitol, furan derivates, for example, 2-furancarboxylic acid, 3-furancarboxylic acid, and/or di- or polyalcohols, for example, ethylene glycol, glycerin or di- or triethylene glycol. Particularly preferably, as conductivity-increasing additives, tetrahydrofuran, N-methylformamide, N-methylpyrrolidone, ethylene glycol, dimethyl sulfoxide or sorbitol are used.

One or more organic binding agents soluble in organic solvents or in water, for example, polyvinylacetate, polycarbonate, polyvinylbutyral, polyacrylic acid esters, polyacrylic acid amides, polymethacrylic acid esters, polymethacrylic acid amides, polystyrene, polyacrylonitrile, polyvinylchloride, polyvinylpyrrolidones, polybutadiene, polyisoprene, polyethers, polyesters, polyurethanes, polyamides, polyimides, polysulfones, silicones, epoxy resins, styrene/acrylic acid ester-, vinylacetate/acrylic acid ester- and ethylene/vinylacetate-copolymers, polyvinyl alcohols or celluloses can also be added to the composition. The proportion of the polymeric binding agent, where used, is usually in the range from 0.1% to 90% by weight, preferably in the range from 0.5% to 30% by weight and particularly preferably 0.5% to 10% by weight, based on the total weight of the coating composition.

In order to adjust the pH value, for example, acids or bases can be added to the coating compositions. Preferably such additives do not impair the film formation of the dispersions, such as for example the bases 2-(dimethylamino)-ethanol, 2,2′-iminodiethanol or 2,2′,2″-nitrilotriethanol.

The coating composition can then be applied using known methods, for example, by spin-coating, dipping, pouring, dropping, injecting, spraying, doctor blade application, painting or printing, for example, inkjet, screen printing, intaglio, offset or pad printing onto the substrate in a wet film thickness of from 0.5 μm to 250 μm, preferably in a wet film thickness of from 2 μm to 50 μm and subsequently dried at a temperature in the range from 20° C. to 200° C.

Preferably, the layer at least partially covering the substrate surface has a layer thickness in the laminated bodies according to the invention in the range from 0.01 μm to 50 μm, particularly preferably in the range from 0.1 μm to 25 μm and especially preferably in the range from 1 μm to 10 μm.

It is further preferable, with regard to the layer construction according to the invention, that the layer B) shows the following properties:
B1) the internal transmission of the layer is greater than 60%, preferably greater than 70% and particularly preferably greater than 80%;
B2) the roughness of the layer (Ra) is less than 50 nm, preferably less than 30 nm, particularly preferably less than 20 nm, and especially preferably less than 10 nm or even less than 5 nm.

In some cases, an internal transmission of up to 99.5% is achieved. Also, in some cases, a surface roughness of at least 0.3 nm is achieved.

A contribution to solving the aforementioned problems is also made by an electronic component comprising a laminate body according to the invention. Preferred electronic components are, in particular, organic light-emitting diodes, organic solar cells or capacitors, wherein the use in capacitors, particularly the use as solid electrolyte in capacitors with aluminium oxide as the dielectric is particularly preferred.

A contribution to solving the aforementioned problems is also made by the use of a composition according to the invention or a composition obtainable with the method according to the invention for producing an electrically conductive layer in electronic components, particularly in organic light-emitting diodes, organic solar cells or capacitors.

The invention will now be described in greater detail by reference to test methods and non-restricting examples.

### Test Methods

Where not otherwise stated, the tests were carried out in a laboratory at a temperature of 21° C. at an atmospheric humidity in the range from 50% to 70% and at atmospheric pressure.

### Determination of Sulfate Content

The sulfate content of the dispersion was determined by ion chromatography. For this purpose, a column provided with ion exchanger was used with subsequent conductivity measurement. The ion chromatograph used was a Dionex 300. An IonPac AG 11 pre-treatment column from Dionex of 50 mm length and 4.0 mm internal diameter and 5 μm particle diameter was used. An IonPac AS 11 separating column from Dionex of 250 mm length and 4.0 mm internal diameter and 5 μm particle diameter was used. Water was used as the eluent. The flow rate was 1.8 ml/min. The injection volume was 50 μl. The retention time for sulfate in this arrangement was approximately 12.5 min. Sulfate ions were detected by means of a conductivity detector with a Dionex ASRS-s suppressor.

For calibration, 95% sulfuric acid (ultrapure) was used. 200 mg sulfate was weighed to 0.1 mg precision into a 1,000 ml measuring cylinder which was then filled with water to the level mark. The precision of the analysis for concentrations>5 mg/kg is 3% based on the measured value. At values in the range from 1 mg/kg to 5 mg/kg, it is a maximum of 10% based on the measured value.

### Determination of Iron Content

The iron content of the dispersion was determined by means of mass spectrometry with inductively coupled plasma (ICP-MS). (Element 2; THERMO). Calibration was carried out with two separate calibration solutions (low and high-standard), for which an internal Rhodium Standard and a multielement solution (from Merck) were used. 2 g of the inventive sample was diluted to 20 ml and utilised. The analysis was carried out at the medium resolution of the mass spectrometer. The isotopes Fe(54), Fe(56) and Rh(103) were detected and, based on the calibration, the iron content of the sample was determined.

### Determination of Conductivity

A cleaned glass substrate was laid on a spin coater and 10 ml of the composition according to the invention was distributed over the substrate. The remaining solution was then spun off by rotation of the plate. Thereafter, the substrate thus coated was dried for 15 minutes at 130° C. on a hot plate. The layer thickness was then determined by means of a layer thickness measuring device. (Tencor, Alphastep 500). The conductivity was determined in that Ag electrodes of 2.5 cm length were vapour deposited at a distance of 10 mm via a shadow mask. The surface resistance determined with an electrometer (Keithly 614) was multiplied by the layer thickness in order to obtain the specific electrical resistivity. The conductivity is the inverse of the specific electrical resistivity.

### Determination of Viscosity

The viscosity was determined using a Haake RV 1 rheometer with a cryostat attached. A DG 43 measuring cylinder with double gap and a DG 43 rotor, both from Haake, were used. 12 g of the aqueous solution was weighed into the measuring cylinder. The temperature was regulated to 20° C. by the cryostat. To establish the desired temperature, the dispersion was first tempered for 240 s at a shear rate of 50 s⁻¹. The shear rate was then increased to 100 s⁻¹. This shear rate was maintained for 30 s. 30 viscosity measurements were then made at a shear rate of 100 s⁻¹ for a further 30 s (1 measurement/second). The mean value of these 30 measurements was then taken as the viscosity of the dispersion.

### Determination of Gelling Behaviour

20 g of the composition was placed in a 250 ml beaker. The composition was then poured over a smooth plastics surface having an inclination angle of 45°.

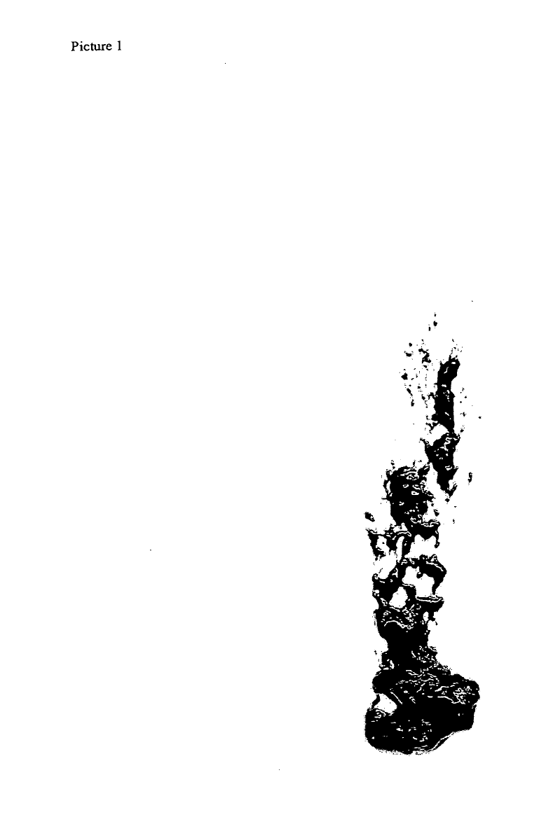

In the case of a gelled composition, the following effects occur:
a) When poured out of the beaker, the composition does not flow out evenly, but leaves behind regions where the composition remains stuck in lumps on the glass wall and regions in which hardly any composition remains.
b) When the material flows over the plastics surface, the material remains in lumps in places. The flow is not uniform, but repeatedly ruptures. [FIG. 1]

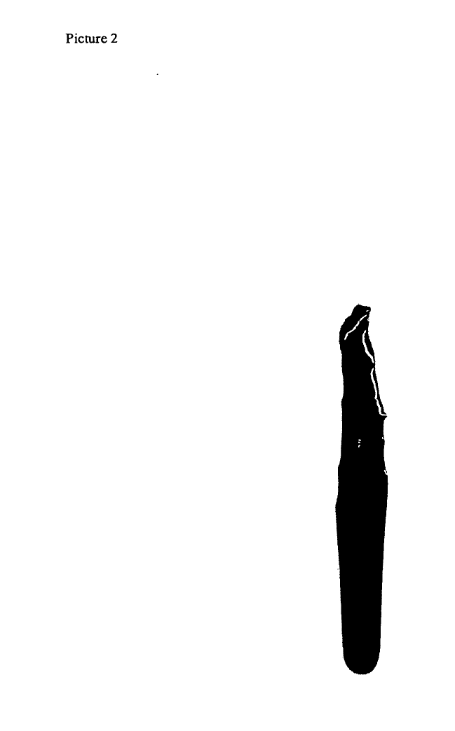

In the case of a homogeneous composition, the following effects occur:
A) When poured out, a uniform film remains on the beaker wall which is thicker or thinner depending on the viscosity of the composition. In every case, the film is uniform and does not show any unevenness.
B) When the material flows over the plastics surface, a uniform film is produced. [FIG. 2]

Based on these criteria, a composition can be classified as gelled or homogeneous.

### Determination of Transmission

The transmission of the coated substrates was determined with a 2-channel spectrometer (Lambda900 from PerkinElmer). In order additionally to detect any portions of the transmitted light scattered by the sample, the device was equipped with a photometer sphere (Ulbricht Sphere). The sample to be measured was fixed in the input aperture of the photometer sphere.

Next, the spectral transmission of the substrate without the coating was measured. The substrates used were glass plates with a thickness of 2 mm, cut into 50 mm×50 mm squares. For coating of the substrate, the substrate was laid on a spin coater and 10 ml of the composition according to the invention was distributed over the substrate. The remaining solution was then spun off by rotation of the plate. Thereafter, the substrate thus coated was dried for 15 minutes at 130° C. on a hot plate.

Next, the spectral transmission of the substrate with the coating was measured. The coating on the substrate was then directed toward the sphere, in front of the photometer sphere.

The transmission spectra in the visible light region were recorded, i.e. from 320 nm to 780 nm, with a step width of 5 nm. From the spectra, the standard colour value Y (brightness) of the sample was calculated according to DIN 5033, on the basis of a 10°-observer and the light type D65. The internal transmission was calculated from the ratio of brightness of the substrate with the coating (Y) to that without the coating (Y0) as follows:

Internal transmission corresponds to Y/Y0*100 percent.

### Determination of Roughness

A cleaned glass substrate was laid on a spin coater and 10 ml of the composition according to the invention was distributed over the substrate. The remaining solution was then spun off by rotation of the plate. Thereafter, the substrate thus coated was dried for 15 minutes at 130° C. on a hot plate.

The roughness of a surface was determined by means of a mechanical profilometer (Tencor Alpha Step 500 from KLA-Tencor). For this, a sensing stylus was moved over a distance of 400 μm and the device recorded the vertical deflection as a function of the horizontal deflection. The mean roughness (Rₐ) was calculated according to the definition thereof (see below and http://de.wikipedia.org/wiki/Rauheit). The contact weight of the sensing stylus was kept small so that the stylus did not alter the surface. This can be checked with repeated recording of the sampling profile at the same site.

### Definition of Mean Roughness (Rₐ)

The mean roughness, represented by the symbol Rₐ, gives the mean distance of a measurement point—on the surface—from the mean line. The mean line intersects the actual profile within the reference path such that the total of the profile deviations (relative to the mean line) is a minimum.

The mean roughness Rₐ, therefore corresponds to the arithmetic mean of the deviations from the mean line. In two dimensions, it is calculated as:

$${R}_{a} = \frac{1}{MN} {\sum }_{m = 1}^{M} {\sum }_{n = 1}^{N} \vert z ( {x}_{m} , {y}_{n} ) - 〈 z 〉 \vert$$

and the mean value is calculated as

$$〈 z 〉 = \frac{1}{MN} {\sum }_{m = 1}^{M} {\sum }_{n = 1}^{N} z ( {x}_{m} , {y}_{n} )$$

### Method

### Particle Determination—Microscopic Investigation

3 drops of the sample to be investigated were placed on a slide with the aid of a pipette and distributed over an area of approximately 1 cm². The slide was then dried for 10 min in a drying cabinet at 100° C. After cooling, the slide was examined under a microscope (Zeiss Axioskop) at 100-times magnification using transmitted light, without a polarising filter.

Images were recorded using a camera (Olympus Altra 20) and at total of five arbitrarily selected 200 μm×200 μm regions were examined and the number of particles of ion exchanger in the five images was counted and the images with the largest particle counts were selected for determination of the particle concentration.

### EXAMPLES

The examples are based on commercially available PEDOT/PSS dispersions from H.C. Starck Clevios GmbH. Since said dispersions are publicly and freely available on the market, no synthesis specifications for the production of the PEDOT/PSS dispersions are given here. Details of the production of such dispersions can however be found, for example, in EP 0 440 957 A2.

### Example 1

For the mixtures, a PEDOT/PSS dispersion with the following properties was used (Clevios P HC V4 from H. C. Starck Clevios GmbH, Leverkusen):
Viscosity: 255 mPas
Solid material content: 1.10%
Sulfate content: 7 mg/kg
Sodium content: 138 mg/kg
Iron content: 0.20 mg/kg
Conductivity: 426 S/cm (measured after addition of 5% dimethyl sulfoxide).
Particle concentration with the above method: none

Different quantities of sulfuric acid were added to 200 g samples of the dispersion. Sulfuric acid has a molar mass of 98 g/mol. It includes 96 g sulfate per mole. This mass of sulfate was taken into account in the following examples. The sulfate quantities are shown in Tables 1 and 2 in mg/kg. The viscosity of the dispersion was determined after 0, 4, 11 and 18 days and it was checked whether the sample had gelled after this time. The viscosity data are summarised in Table 1.

TABLE 1
Viscosity of the PEDOT:PSS dispersion produced in Example
1 after addition of sulfate and following storage

| Sulfate | Viscosity following production and storage [mPas] | | | |
|---|---|---|---|---|
| content [mg/kg] | 0 days | 4 days | 11 days | 18 days |
| 7 | 255 | 256 | 255 | 252 |
| 30 | 230 | 232 | 239 | 235 |
| 60 | 230 | 238 | 243 | 236 |
| 100 | 229 | 226 | 228 | 230 |
| 200 | 200 | 205 | 210 | 205 |
| 300 | 167 | 168 | 170 | 171 |
| 500 | 142 | 154 | 174 | 175 |
| 1000 | 156 | 157 | 199 | 205 |
| 2000 | 132 | 178 | Gelled | Gelled |

The conductivity of the samples was also determined after production. For this purpose, 5 g dimethyl sulfoxide was added to 95 g of the aforementioned mixture of PEDOT/PSS dispersion and sulfuric acid and the conductivity of these samples was determined. The results are shown in the following Table 2.

TABLE 2
Conductivity of PEDOT/PSS dispersions from Example
1 with different sulfate concentrations

| Sulfate | Conductivity with |
|---|---|
| content [mg/kg] | 5% DMSO [S/cm] |
| 7 | 585 |
| 30 | 624 |
| 60 | 619 |
| 100 | 709 |
| 200 | 662 |
| 400 | 704 |
| 600 | 698 |
| 800 | 690 |
| 1000 | 710 |
| 2000 | 750 |

Using the example of the glass substrate, which was coated with the dispersion comprising 200 mg/kg sulfate, the roughness and the transmission were determined. The roughness of the sample was 3.53 nm. The layer thickness of the sample was 142 nm and the internal transmission of the sample was 88.6%.

### Example 2

2000 g of a PEDOT/PSS dispersion (Clevios PH 500, from H.C. Starck Clevios GmbH) with a solid content of 1.10% was concentrated with the aid of ultrafiltration to a solid content of 2.20%. The dispersion was then placed in a column filled with 500 ml of ion exchanger resin (Lewatit M P 62, from Saltigo). The dispersion obtained had the following properties:
Viscosity: 103 mPas
Solid material content: 1.98%
Sulfate content: 1 mg/kg
Sodium content: 5 mg/kg
Conductivity: 425 S/cm (measured after addition of 5% dimethyl sulfoxide).
Iron content 0.19 mg/kg
Particle concentration with the above method: none

Sodium sulfate was added to this dispersion. Different quantities of sodium sulfate were added to 200 g samples of the dispersion according to the procedure in Example 1. The sulfate quantities are shown in Tables 3 and 4 in mg/kg. The viscosity of the dispersion was determined after 0, 4, 11 and 18 days and it was checked whether the sample had gelled after this time.

TABLE 3
Viscosity of the PEDOT:PSS dispersion produced in Example
2 after addition of sulfate and following storage

| Sulfate | Viscosity following production and storage [mPas] | | | |
|---|---|---|---|---|
| content [mg/kg] | 0 days | 4 days | 11 days | 18 days |
| 1 | 103 | 104 | 101 | 102 |
| 30 | 100 | 98 | 102 | 102 |
| 60 | 93 | 95 | 94 | 96 |
| 100 | 90 | 92 | 93 | 94 |
| 200 | 76 | 81 | 82 | 86 |
| 400 | 66 | 73 | 79 | 83 |
| 600 | 60 | 73 | 85 | 95 |
| 800 | 59 | 80 | 96 | 112 |
| 1000 | 57 | 93 | 127 | 139 |
| 1200 | 58 | 110 | 157 | 179 |
| 1400 | 64 | 141 | 216 | 239 |
| 1600 | 67 | 168 | 226 | 269 |
| 1800 | 76 | 191 | 276 | 319 |
| 2000 | 80 | 200 | 298 | 340 |

The conductivity of the samples was also determined after production. For this purpose, 5 g dimethyl sulfoxide was added to 95 g of the aforementioned mixture of PEDOT/PSS dispersion and sulfuric acid and the conductivity of these samples was determined. The results are shown in the following Table 4.

TABLE 4
Conductivity of PEDOT/PSS dispersions from Example
2 with different sulfate concentrations

| Sulfate | Conductivity with |
|---|---|
| content [mg/kg] | 5% DMSO [S/cm] |
| 1 | 425 |
| 30 | 428 |
| 60 | 440 |
| 100 | 468 |
| 200 | 480 |
| 400 | 480 |
| 600 | 490 |
| 800 | 468 |
| 1000 | 434 |
| 2000 | 417 |

Using the example of the glass substrate, which was coated with the dispersion comprising 200 mg/kg sulfate, the roughness and the transmission were determined. The roughness of the sample was 1.39 nm. The layer thickness of the sample was 66 nm and the internal transmission of the sample was 95.2%.

The results from Examples 1 and 2 show that a particularly advantageous combination of the properties high conductivity and advantageous storage stability can be achieved if a sulfate content in the range from 100 ppm to 1,000 ppm in the PEDOT/PSS dispersion is ensured. If the sulfate content is lower than 100 ppm, although advantageous storage stability can be achieved, the conductivity is relatively low. If the sulfate content is greater than 1,000 ppm, the conductivity is high, but only at the cost of poorer storage stability.

1. A method for producing a composition comprising a polythiophene, comprising the method steps:
I) provision of a composition Z1 comprising thiophene monomers and an oxidising agent;
II) oxidative polymerisation of the thiophene monomers by reducing the oxidising agent to a reduction product and oxidation of the thiophene monomer, to form a composition Z2 comprising a polythiophene and the reduction product;
III) at least partial removal of the reduction product from the composition Z2 obtained in method step II), to obtain a composition Z3;
wherein the composition Z3 has a sulfate content in a range from 100 ppm to 1,000 ppm, based on the total weight of the composition Z3.

2. The method according to claim 1, wherein the composition Z3 comprising polythiophene has a sulfate content in the range from 100 to 500 ppm, based on the composition Z3.

3. The method according to claim 1, wherein the composition Z3 comprising polythiophene has a sulfate content in the range from 100 to 200 ppm, based on the composition Z3.

4. The method according to claim 1, wherein the sulfate content of the composition Z3 is adjusted by addition of sulfuric acid or a salt of sulfuric acid to composition Z3.

5. The method according to claim 1, wherein the thiophene monomer is 3,4-ethylenedioxythiophene (EDT) and the polythiophene is poly(3,4-ethylenedioxythiophene) (PEDOT).

6. The method according to claim 1, wherein the composition Z1 provided in method step I) comprising thiophene monomers and an oxidising agent, also comprises a polyanion.

7. The method according to claim 6, wherein the polyanion is a polystyrene sulfonic acid (PSS).

8. The method according to any one of the preceding claim 1, wherein the composition Z3 is a PEDOT/PSS dispersion.

9. The method according to any one of the preceding claim 1, wherein the salt of sulfuric acid is an alkali salt or an ammonium salt of sulfuric acid or a mixture thereof.

10. The method according to claim 9, wherein the alkali salt of sulfuric acid is sodium sulfate.

11. The method according to claim 1, wherein the at least partial removal of the reduction product in method step III) takes place through the treatment of the composition Z2 with an ion exchanger.

12. A composition obtainable as composition Z3 by a method according to claim 1.

13. A composition comprising a polythiophene, wherein the composition comprises, in addition to the polythiophene, in the range from 100 ppm to 1,000 ppm of sulfate, based on the total weight of the composition.

14. The composition according to claim 13, wherein, in addition to the polythiophene, the composition comprises in the range of from 100 ppm to 500 of sulfate, based on the total weight of the composition.

15. The composition according to claim 13, wherein, in addition to the polythiophene, the composition comprises in the range of from 100 ppm to 200 of sulfate, based on the total weight of the composition.

16. The composition according to claim 13, wherein the composition comprises less than 20 ppm of iron, based on the total weight of the composition.

17. The composition according to claim 13, wherein the polythiophene is poly(3,4-ethylenedioxythiophene).

18. The composition according to claim 13, wherein, in addition to the polythiophene, the composition comprises a polyanion.

19. The composition according to claim 19, wherein the polyanion is a polystyrene sulfonic acid.

20. The composition according to claim 13, wherein the composition is a PEDOT/PSS complex.

21. The composition according to claim 20, wherein the composition has at least one of the following properties:
i) a viscosity in the region from 60 mPas to 250 mPas;
ii) a conductivity, determined according to the test method described herein, of at least 400 S/cm;
iii) a PEDOT/PSS content in the range from 1% to 5% by weight, based on the total weight of the composition.

22. A layer construction, comprising
A) a substrate with a substrate surface and
B) a layer at least partially covering the substrate surface,
wherein the layer is made from a solid comprised in a composition according to claim 12.

23. The layer construction according to claim 22, wherein the layer B) has the following properties:
B1) the internal transmission of the layer is greater than 80%;
B2) the roughness of the layer (Rₐ) is less than 20 nm.

24. An electronic component comprising a layer construction according to claim 22.

25. A method for producing an electrically conductive layer in an electronic component, the method comprising applying the composition of claim 12 to a substrate surface.
